(19) United States
(12) Patent Application Publication
(10) Pub. No.: US 2009/0150260 A1
(43) Pub. Date: Jun. 11, 2009

(54) System and method of dynamic generation of a user interface

(76) Inventors: Carl Koepke, Chicago, IL (US); Frank Bernard, Lakewood, IL (US); George Prenta, Western Springs, IL (US)

Correspondence Address: Valauskas & Pine LLC, 150 South Wacker Drive, Suite 620, Chicago, IL, 60606, US

(21) Appl. No.: 12/291,855

(22) Filed: Nov. 14, 2008

Related U.S. Application Data
(60) Provisional application No. 61/003,420, filed on Nov. 16, 2007.

(51) Int. Cl. G06Q 30/00; G06F 3/14

(52) U.S. Cl. 705/27; 715/733

(57) ABSTRACT

The present invention is a system and methods of the dynamic generation of a user interface with form elements in proximity to a schematic or diagram of a product for the purposes of data entry. More specifically, form elements allow the gathering of data such as quantity, finish, size, color, engraving, for the purposes of ordering product from an online Shopping System.

### FIELD OF THE INVENTION

The present invention generally relates to user interfaces and more specifically to a system and methods of dynamically generating the design and display of user interfaces on the World Wide Web (WWW).

### BACKGROUND OF THE INVENTION

The World Wide Web (commonly shortened to the Web) is a system of interlinked, hypertext documents accessed via the Internet. A Web page or webpage is a resource of information that is suitable for the World Wide Web and can be accessed through a web browser. This information is usually in Hypertext Markup Language (HTML) or Extensible Hypertext Markup Language (XHTML) format, and may provide navigation to other web pages via hypertext links.

Web pages may be retrieved from a local computer or from a remote web server. The web server publishes pages on the World Wide Web. Web pages are requested and served from web servers using Hypertext Transfer Protocol (HTTP).

The World Wide Web includes online Shopping Systems for retailing. Retailing is the sale of products or merchandise. Online Shopping Systems allow a customer to browse, gather information and purchase products or merchandise through a web page on the Internet. Typically web pages of online Shopping Systems present products by category, cost, or allow the customer to search for products using a search function. Current online Shopping System web pages fail to organize and present objects related to products in a dynamically generated user interface for easy interaction and purchase.

Typically the format of a HTML web page is limited by the rendering capabilities of web browsers. The format of a web page includes the appearance and layout, or design and display, of objects such as text, figures, diagrams schematics, form elements to name a few. Objects are usually limited to display in tabular or linear format. The advent of advanced browser rendering capabilities allow for more advanced design and display of objects in the web browser.

A web page user interface that is dynamically generated is desirable for easy interaction and purchase of products. The present invention satisfies this demand.

### SUMMARY OF THE INVENTION

The present invention is discussed herein with reference to the online retail industry, but the present invention is applicable to a variety of contexts and environments, each of which may utilize the dynamic generation of a user interface, for example, for sales, financial, legal, tax, insurance, and research purposes.

The present invention includes a method to dynamically generate a user interface. The user interface includes a schematic with a form element in proximity, or juxtapose, to the features of the schematic. Further, data is entered into the form element. It is contemplated the present invention is not only applicable to schematics, but any visual display for purchasing product such as a graphical view of store shelves containing a variety of products.

Form elements are in HTML format and include a data entry field, for example a drop-list box for entry of a quantity, finish, size, color, engraving, to name a few. More specifically, form elements allow the gathering of various data for the purposes of ordering products from an online Shopping System. It is contemplated that the Shopping System utilizes a shopping cart for gathering information about products that a visiting customer may purchase.

A schematic for purposes of this application is a diagram or photographic image of a whole object, such as a product, including its features such as the collection of individual objects or parts that comprise the product. For purposes of this application, a whole object, or product, is considered the “parent” and the underlying individual objects, or parts, considered the “children” or “child”.

According to the present invention, a Schematic Manager (SM) is used to create the user interface on the WWW. For purposes of this application, a user is someone who utilizes the Schematic Manager to create the user interface and a customer is someone who views the user interface on the WWW. The Schematic Manager includes a product review pane for descriptive information about the product for which schematics will be managed, upload pane for uploading files, such as a schematic image in a GIF or JPEG or PNG format, to the server for processing, and a schematic pane. One or more schematic images for a product are stored in a repository. The schematics pane includes an image display area and a table of individual objects, or parts, that comprise the product. The image display illustrates each uploaded schematic image file associated with the product. The Schematic Manager includes a marker that corresponds to the form element displayed on the user interface. A user positions each marker to a feature on the schematic in the display area. As a result, the marker populates an underlying form element for display on the user interface. The marker approximates the size, shape and position of the form element that is generated and viewed by the customer on the user interface. It is further contemplated that a user of the Schematic Manager can create parent-child relationships between products (parent) and its parts (children).

When a customer accesses an online Shopping System, a web browser requests a resource from a web server. Data is interpreted by an application on the web server to dynamically generate a user interface. The user interface presents the customer with schematics for each product including thumbnails of the schematics when there is more than one schematic for a product. When there is more than one schematic for a product, a customer can click on a thumbnail for the desired schematic. The schematic is presented with the form elements superimposed in proximity to the features of the schematic. The customer makes his or her selections, such as quantity, finish, size, color, engraving, via the form elements, and proceeds with the purchase order in the shopping cart system.

An object of the present invention presents customers with an easy to use interface when ordering products.

Another object of the present invention is to display form elements in proximity to the schematic in the context of a web browser using data retrieved from a repository that can be dynamically updated, as opposed to using static files.

Another object of the present invention is to store references to products such that requests for information about the product can be used to display schematic diagrams of the parent product and child parts.

Another object of the present invention is to illustrate multiple schematics in a simple table of clickable thumbnails, although it is also contemplated that multiple schematics can be layered into a three dimensional ‘fly-through’ for products presented in cutaway, or three dimensional ‘fly-around’ for products with several perspective views.

An object of the present invention is to utilize any characteristics provided by the Shopping System, while presenting the customer with an easy to use interface for identifying and purchasing products including underlying parts.

Yet another object of the present invention is to augment the default display of products of a Shopping System at the purchase point.

Yet another object of the present invention is implementation on any existing or contemplated online Shopping System.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

FIG. 1A illustrates a screen shot of a web page according to the present invention;

FIG. 1B illustrates a perspective view of the screen shot of FIG. 1A according to the present invention;

FIG. 2 illustrates a diagrammatic representation of a computer network according to the present invention;

FIG. 3 illustrates database table structures with included sample datasets according to the present invention;

FIG. 4 illustrates the Schematic Manager (SM) according to the present invention;

FIG. 5 is a flowchart of Comma-Separated Variable (CSV) data management according to the present invention;

FIG. 6 is a flowchart of schematic image file management according to the present invention;

FIG. 7 illustrates a code fragment of the XML data structure and content for schematic data according to the present invention;

FIG. 8 illustrates a code fragment used to describe the mechanisms of the Schematic Manager according to the present invention;

FIG. 9 is a flowchart of generating the Schematic Manager according to the present invention;

FIG. 10 illustrates a code fragment used to display markers and form elements relative to the schematic image according to the present invention; and

FIG. 11 is a flowchart of generating the customer interface using schematic data according to the present invention.

### DETAILED DESCRIPTION OF EMBODIMENTS OF THE INVENTION

The present invention relates to dynamic generation of a user interface with form elements in proximity to features, such as individual parts, of a schematic or diagram of a product for the purposes of data entry. More specifically, form elements allow the gathering of a simple quantity value for the purposes of ordering product from an online Shopping System.

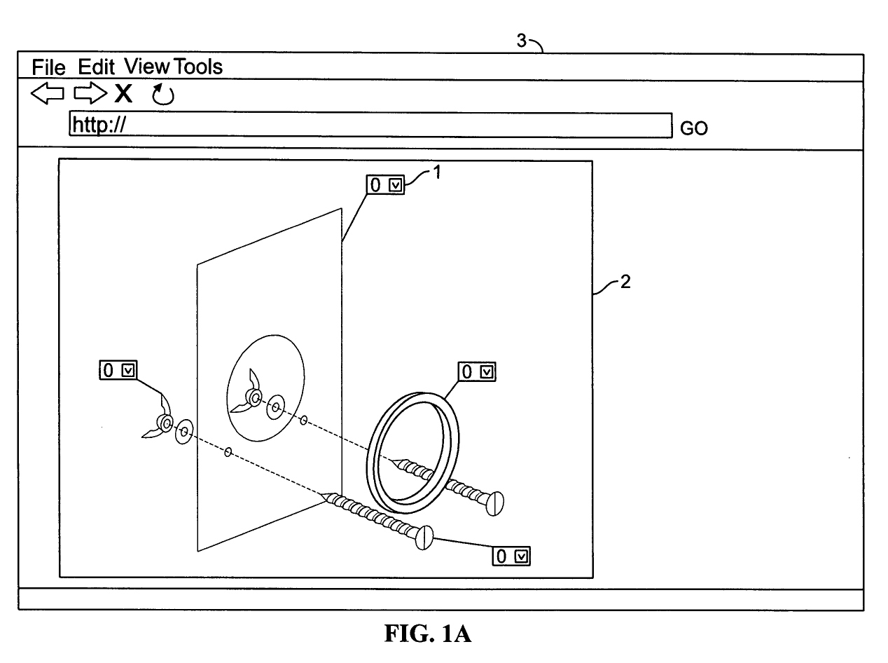

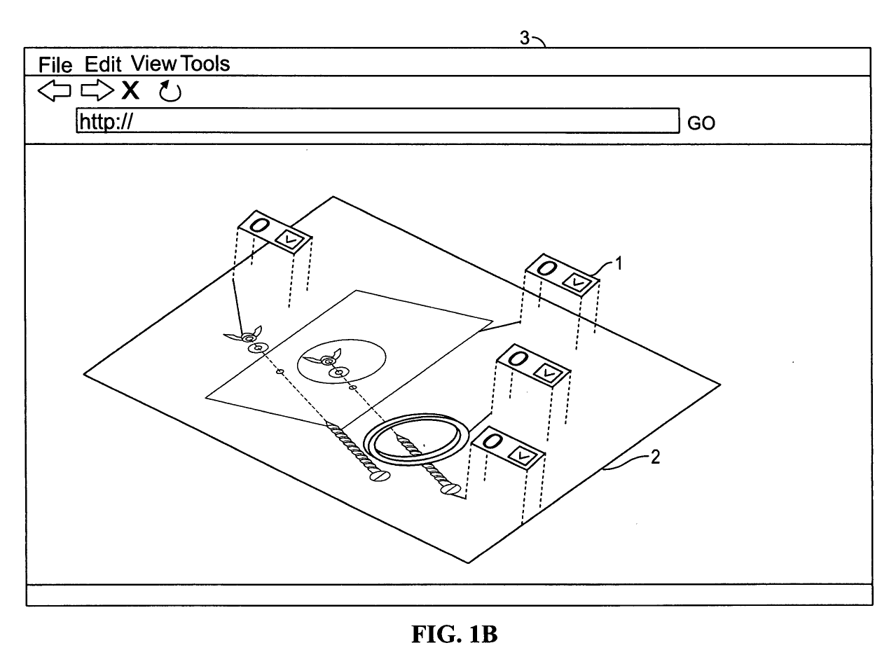

FIGS. 1A and 1B illustrate a screen shot of a web page according to the present invention. Web browser window 3 includes a schematic 2 with form elements 1 positioned in proximity to features, such as individual parts, of the schematic 2. The form elements 1 are presented in the foreground of the schematic 2.

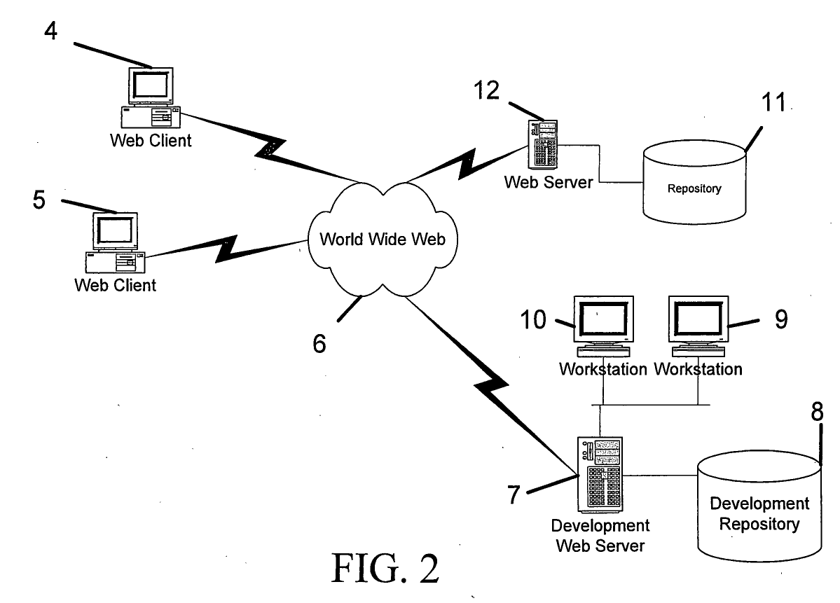

FIG. 2 illustrates a diagrammatic representation of a computer network, more specifically a client/server system configuration. A development server 7 is connected to workstations 9 and 10 and is also connected to development repository 8. Development server 7 is also connected to the World Wide Web (WWW) 6 using a network connection. It is contemplated that the development server 7 can be any computing system capable of operating in a computer network environment and capable of hosting web server software. The development repository 8 is used as a database for the development process and stores scripts, programs, images, data files and form object data to be used in development. Web server 12 is essentially a functional version of the development server 7, differing only in that it interacts with the public, i.e., the web server 12 is not for development. Repository 11 is essentially a functional version of the development repository 8. Repository 11 interacts with the public and is not for development like development repository 8. Web clients 4 and 5 are any computing platform capable of hosting a web browser application.

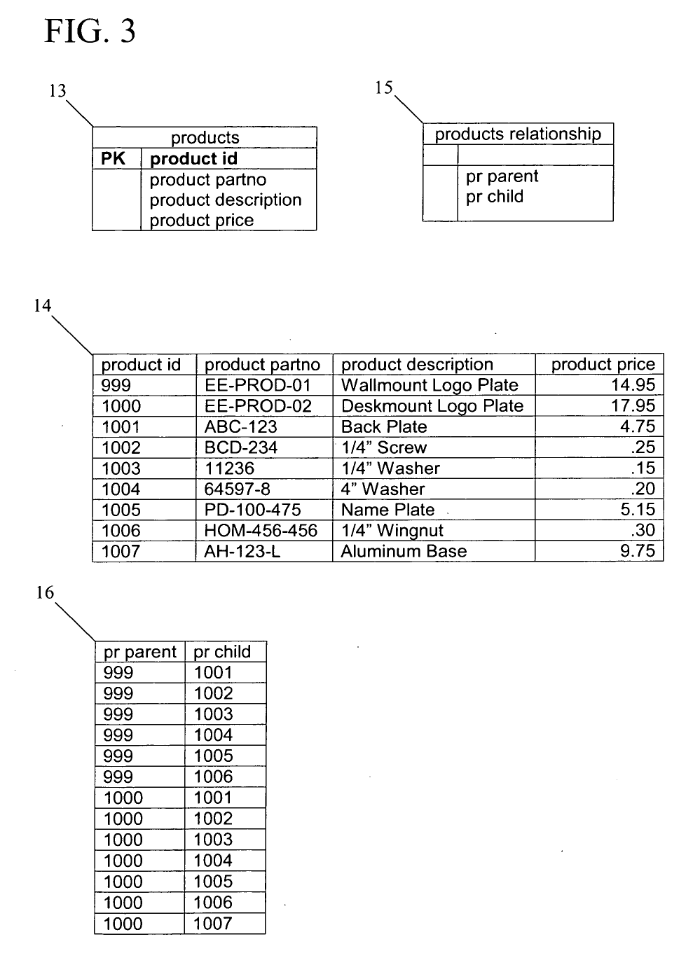

FIG. 3 illustrates database table structures with included sample datasets according to the present invention. Products table 13 contains information 14 about the products, including parts of the product, available from the Shopping System. The products relationship table 15 contains information 16 regarding the relationships (parent-child) between entries in the products table 13. As specifically illustrated in FIG. 3, for example executing the SQL query ‘SELECT pr_child from table products_relationships WHERE pr_parent=‘1’, a list of all parts that comprise the collection of parts for the product with a product_description of ‘Wallmount Logo Plate’ would result.

For each product, a user is provided a schematic or photographic representation of the product including the collection of parts, an image of the product, and a table of textual data that contains identifying and descriptive data about the product and its collective parts. The textual data is typically provided as a spreadsheet file or delimited text file.

Using an image editing application, the user performs editing functions upon the images for display on the Shopping System and saves the image in a format suitable for display. The user uses a spreadsheet application to arrange the textual data that describes parts of the collection into a predetermined structure and saves the textual data in the Comma-Separated Variable (CSV) format as shown in the table below:

| product partno | product description | price |
|---|---|---|
| ABC-123 | Back Plate | 4.75 |
| BCD-234 | ¼″ Screw | 0.25 |
| 11236 | 3″ Washer | 0.15 |
| 64597-8 | 4″ Washer | 0.20 |
| AH-123-L | Aluminum Base | 9.75 |
| PD-100-475 | Name Plate | 5.15 |
| HOM-456-456 | ¼″ Nut | 0.30 |

Using the Shopping System's existing methods, the user creates a new product entry for the parent product. The user then views the completed product page in the Shopping System's administrative interface and clicks a ‘Manage Schematics’ button that executes the Schematic Manager (SM) script on the server and passes a reference to the product's ID as stored in the RDBMS. A Schematic Manager (SM) is used to create the user interface displayed to the customer on the WWW.

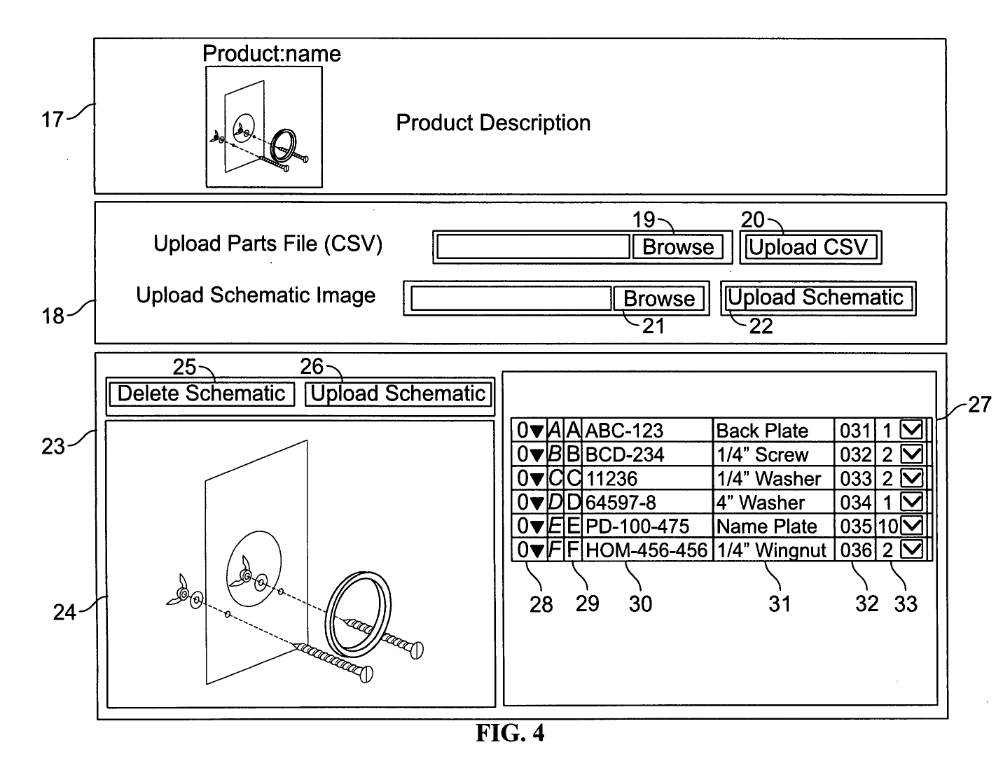

FIG. 4 illustrates the Schematic Manager (SM) according to the present invention. The Schematic Manager is provided to a user via a browser window in any known method utilizing HTML and browser compliant scripting technologies, such as JavaScript. The Schematic Manager includes a product review pane 17 where the user is presented with descriptive information about the product for which schematics will be managed. The Schematic Manager also includes an upload pane 18 that displays HTML form objects 19, 20, 21, 22 that allows the user to select a file to upload into the server for processing. Form objects include, as shown in FIG. 4, Comma-Separated Variable (CSV) upload elements 19, 20 and file upload of a schematic image file 21, 22. Upon selection and execution of a file to upload, the file is sent to the server hosting the Shopping System and processed.

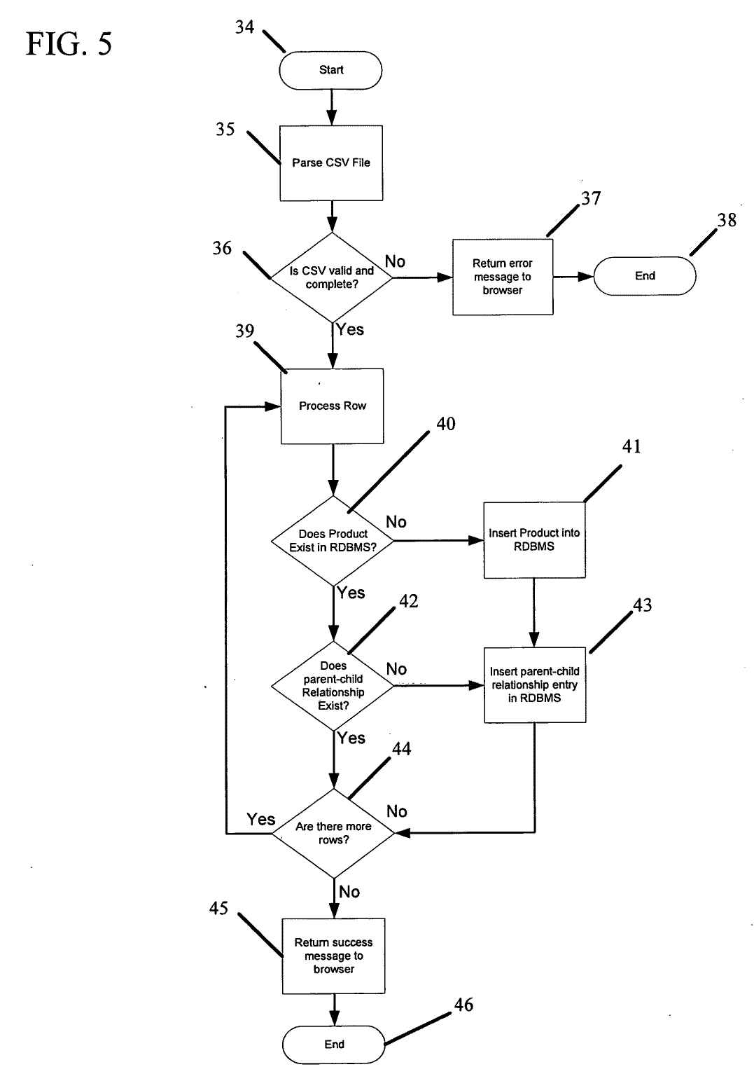

FIG. 5 is a flowchart of Comma-Separated Variable (CSV) data management according to the present invention. To process a parts collection CSV file, the process begins in the client browser at step 34 once the user selects the upload button 20 (see FIG. 4). The server application parses the uploaded file at step 35 followed by an inquiry at step 36 as to whether the data is complete and in the proper form. If the data is not complete and in the proper form, a HTML error message is sent to the browser at step 37 to notify the user and the application terminates at step 46. If the data is complete and in the proper form, the server iterates through the CSV file at step 39. The server iterates through the file row by row using known methods to those skilled in the art.

For each row in the CSV file, an inquiry is made to the Relational Database Management System (RDBMS) at step 40 as to whether the product is already present. Most Shopping Systems use a RDBMS to store information about the products, customers and purchase orders. According to the present invention, the user has access to a parent-child relationship between products and its parts. To create this relationship, the RDBMS may need to be modified to have a single table that stores information used to determine the children parts of any given parent product. If the product does not already exist, it is inserted into the RDBMS as a new product at step 41 and the parent-child relationship is created and inserted into the RDBMS in step 43. If the product already exists in the RDBMS at step 40, an inquiry is made at step 42 as to whether a parent-child relationship between the product and part exists. If there is no relationship, the parent-child relationship is created and inserted into the RDBMS in step 43. After a parent-child relationship is created and inserted at step 43 or if a relationship already exists at step 42, an inquiry is made at step 44 as to whether there are more rows to be processed. If the answer is yes, then a return is made back to step 39 and the process repeats until there are no more rows to be processed at step 44. Upon no more rows within the CSV file to be processed, a success message is sent to the user's browser at step 45 and the application terminates at step 46.

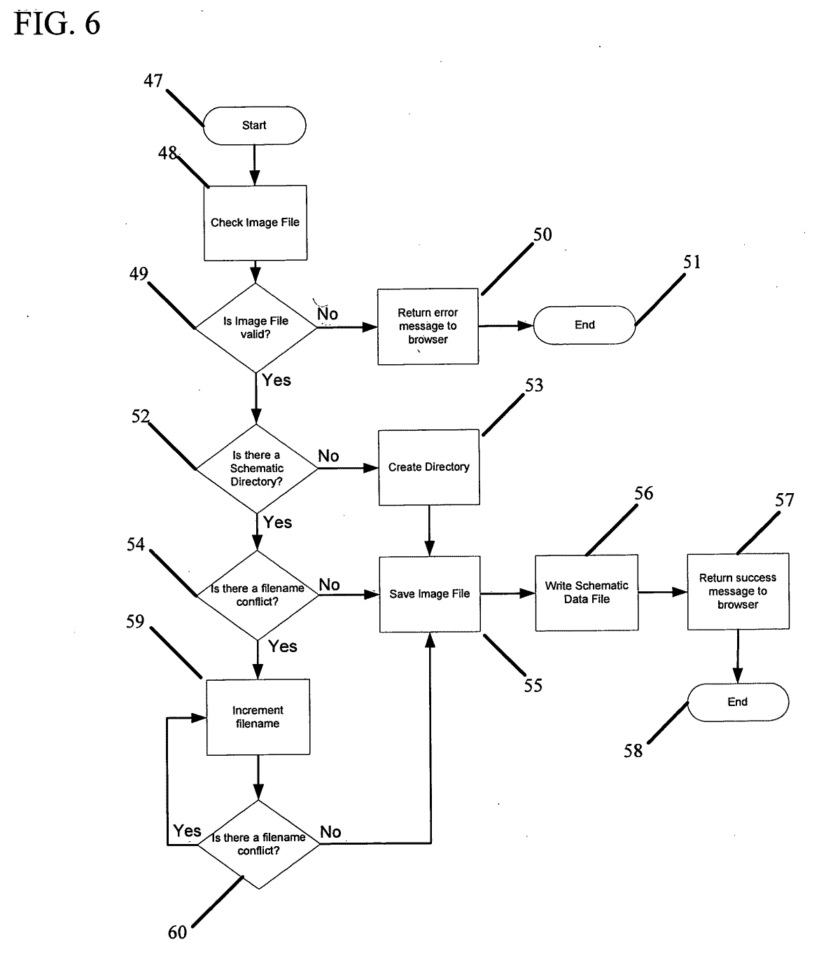

FIG. 6 is a flowchart of schematic image file management according to the present invention. To process a schematic file, the process begins in the client browser at step 47 once the user selects the upload button 22 (see FIG. 4).

The server application parses the uploaded file at step 48. The server verifies that the image file is in a valid format and calculates its size in terms of height and width. This is followed by an inquiry at step 49 as to whether the data is complete and in the proper form. The inquiry at step 49 includes checking the compatibility of the image file format with display in a Web browser and whether it falls within predetermined height and width constraints. If the image file format does not fall within the predetermined constraints at step 49, an error notifying the user that the file contains invalid content or is over the size limit set by the software application is generated and returned to the browser window in the form of HTML at step 50 and the application terminates at step 51. If the image file is valid at step 49, an inquiry is made as to whether a directory in the file system of the server is available at step 52.

Schematic image files and schematic data files are stored in the server's file system based upon the product's ID as stored in the Shopping System's RDBMS. Schematic data files are in an XML format that stores information about markers and product information. For example, if the parent product's information (description, price etc.) is stored in the RDBMS under product_ID 7553, the application will check for a directory named “7553” on the file system, otherwise referred to herein as a target directory. If the target directory does not exist, a directory is created at step 53 and continues to step 55 where the image file is saved in the target directory at step 55. The image file is derived from the product's ID in the same manner as the target directory, for example, if the product ID is 7553, the image will be stored as 7553.[extension] where [extension] is the proper file type extension, e.g., jpg, png, or gif. If a schematic directory and target directory exists at step 52, the software application checks to see if there is a filename conflict at step 54. For example, if the application is attempting to store a schematic image file with a name of 7553.png and there is already a file in the target directory of the same name, the application will append the file name by adding a number to the file name at step 59 such as 7553_{—}1.png. The application increments the number for an appended file name at step 59 until there is no longer a file name conflict at step 60. When no file name conflicts exist at steps 54 and 60, the image is saved to the file system at step 55. The application then creates a new schematic data file at step 56, returns a success message to the browser at step 57 and terminates at step 58. The schematic data consists of computer-readable code in an XML document and is described below.

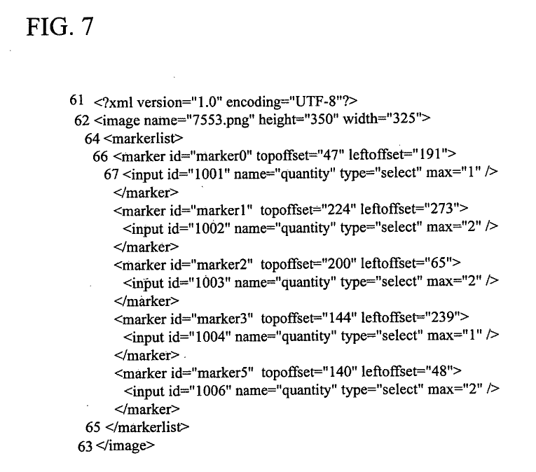

FIG. 7 illustrates a code fragment of the XML data structure and content for a schematic data file according to the present invention. The example shown in FIG. 7 represents a schematic data file for schematic image file 7553, as described in the above scenario and as illustrated in the figures provided. The source data begins with an XML declaration 61 that describes the version of XML that is being used, and the character encoding that is being used. This declaration is described in the W3C Recommendation 6 Oct. 2000, a working specification for the XML standard, available at http://www.w3.org/TR/2000/REC-xml-20001006, incorporated herein by reference. All data is enclosed in an outer-level grouping construct <image> tag at 62 and the ending tag </image> at 63. Within the enclosing <image> construct is a single <markerlist> construct beginning at 64 and ending at 65. Within the <markerlist> construct is zero or more <marker> constructs, which in turn contain an <input> construct 67. The <image> construct contains attribute “name” that is used to determine the schematic image file associated with this schematic data file. The height and width attributes in the <image> construct denote the height and width of the image as calculated in step 48 of FIG. 6. Each <marker> construct contains attribute “ID” that is used to assign the construct a unique keyword name in the construct, a top offset attribute that represents the Cartesian y axis coordinate of the marker relative to the upper left origin of the schematic image file, and a left offset attribute that that represents the Cartesian x axis coordinate of the marker relative to the upper left origin of the schematic image file. As an example of the top offset and left offset attributes, the <marker> construct at 66 represents a marker that was placed 47 pixels down and 191 pixels right of the upper left corner of the schematic image display area. Each <input> construct contains an “ID” attribute that is used to represent the RDBMS product ID for the part associated with the marker, a “name” attribute that represents the modifying attribute that the shopping cart system uses to store an line-item quantity value in its shopping cart, a “type” attribute that is used to generate an HTML form element appropriate for capturing customer input, and a “max” attribute that is also used to generate the HTML form element for capturing customer input, the value of the “max” attribute is set by the user using the Schematic Manager by setting a value using the form elements in column 33 illustrated in FIG. 4.

Referring again to FIG. 4, a schematic pane 23 is shown for each uploaded schematic. Each schematic pane 23 contains a “Delete Schematic” button 25. This button, when activated, executes software code to remove the schematic image file and schematic data from the server file. Each schematic pane 23 also includes an “Update Schematic” button 26 that submits HTML form information associated with the target schematic when activated. The schematic pane 23 also contains a schematic image display area 24 that displays a schematic image file, and a table of parts 27. The table 27 displays all individual parts that have been identified as children of the parent product. The table of parts 27 is constructed from a database and has an entry, or row, for each part within a collection of parts.

Underlying the visible interface, each schematic pane 23 has a dedicated HTML form that is executed by selecting the “Update Schematic” button 26. For example, if there is more than one schematic pane 23 displayed, clicking “Update Schematic” button 26 in the first schematic pane will only submit data related to the first schematic pane for processing on the server.

The table of parts 27 consists of various columns 28, 29, 30, 31, 32, 33. Column 28 contains a marker that is an image of a standard HTML select box, commonly referred to as a drop list, and a text key useful in associating the marker with the row of information when the user has moved the marker and wishes to cross reference the associated row of part information to ensure proper placement of each marker. The marker is not a functional form element; it serves as a reference for the user to use when placing the marker over the schematic image display area 24. For example, in this embodiment of the invention, the Shopping System will display functioning drop list form elements that capture a quantity value from the customer using the Shopping System. The form elements will be displayed in proximity, or juxtaposition, with features such as individual parts of the schematic image using data generated by the Schematic Manager. The marker is thus a facsimile of the form element that will be displayed on the customer user interface. If the embodiment were to display a different form element or group of form elements, for example, a text box for data entry, the marker could be an image of the text box. In this manner, the user can gauge what the customer interface will look like. The user, using a mouse or other pointing device, can move each marker by clicking and dragging the marker around the web page. When the user releases the mouse button, the marker remains where it has been dropped. Column 29 is used as a reference key and contains the same text as the marker text. Column 30 contains the manufacturer's number or SKU, column 31 contains a description of the product or part, and column 32 contains the product ID as stored in the RDBMS. Columns 30 through 32 are derived from the parts collection CSV file that the user has uploaded. Column 33 contains an example of meta information that can be collected in the Schematic Manager interface, in this embodiment it is a drop list that captures a value that will determine the maximum value of the quantity drop list that will be displayed to the customer. If the user wants the drop list for the part listed in the first row to only allow the customer a choice between “zero” and “two” in quantity, the user would set the drop list in column 33 to “two” in the first row. In a preferred embodiment of the invention, when a user places a marker by dragging it with a mouse, a JavaScript software element of the HTML page tracks the movement and events of the mouse and captures the Cartesian coordinates of the marker in relation to the upper left corner of the schematic image display area.

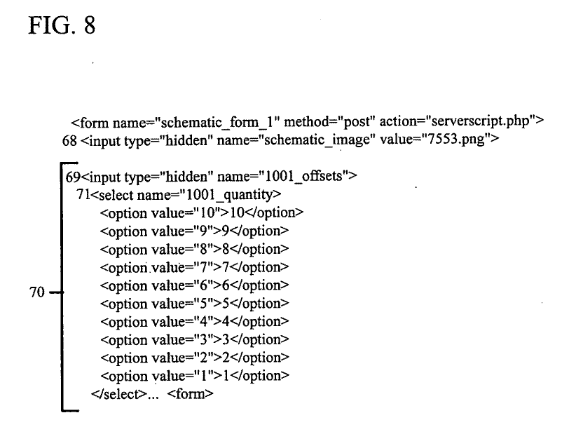

FIG. 8 illustrates a code fragment used to describe the mechanisms of the Schematic Manager according to the present invention. As shown in FIG. 8, the marker's Cartesian coordinates are stored in hidden form field 69 that is contained within the schematic and is named such that it is associated with the part corresponding with the marker. For example, if the user moved a marker associated with part 1001 to a place offset by 45 in the X plane and 124 in the Y plane, form element 69 would be changed to read <input type=“hidden” name=“1001_offsets” value=“45, 124”> through JavaScript event handlers. For each schematic pane 23, the form contains a hidden input field that contains as its value the name of the schematic image that is displayed in the schematic image display area 68. A block of code 70 is generated for each part that is identified as a child of the parent product. In this example, the part being represented by this code block is stored in the RDBMS with an ID of 1001. Within each block of code 70, there is a hidden input field 69 that is populated by the action of the user placing a marker as described above, and HTML form code that creates a ‘select’ form input 71 that allows the user to choose a max value as described in reference to FIG. 4. Within each block 70, the hidden input element and the select form input's names are derived from the part's RDBMS ID.

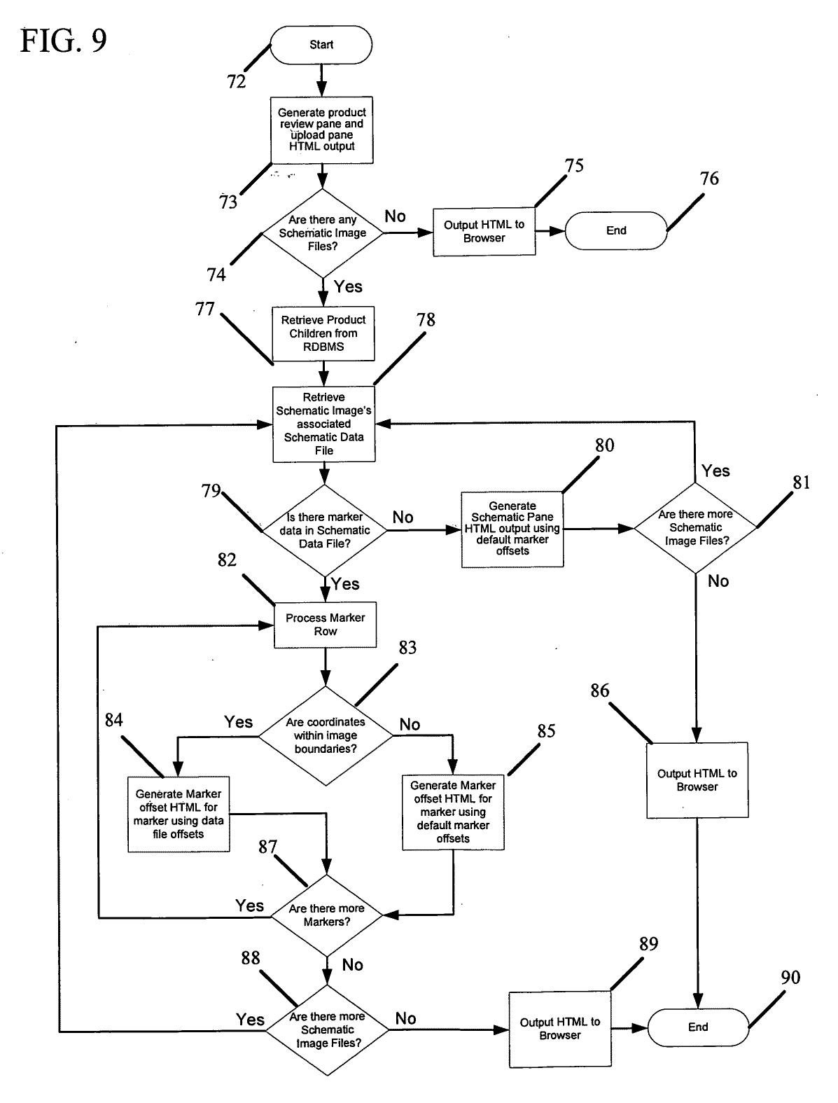

FIG. 9 is a flowchart of generating the Schematic Manager according to the present invention. At step 72, the user selects a ‘Manage Schematics’ button within the browser while viewing a product page in the Shopping System's administrative interface. The form that creates the ‘Manage Schematics’ button contains a hidden form field element that contains the product's ID as stored in the Store's RDBMS. From this ID reference, the application creates the form interface at step 73 for the product review pane and upload pane by retrieving descriptive information from the RDBMS using the product ID and placing hidden form field elements in the upload interface form that includes the product ID. In this manner, when a user uploads a CSV or schematic image file, the application that receives the form submission can associate the CSV with the product as described above, and store the schematic image and data files using the product ID as described above. The process then executes an inquiry at step 74 which reads the server's file system and looks for a directory with a name equivalent to the product ID and the presence of any schematic image files using methods known to those skilled in the art. If there is no directory and/or no schematic image files present, the HTML generated in step 73 is output at step 75 back to the browser and the application terminates at step 76.

If there is a directory and/or schematic image file present, part data is retrieved from the RDBMS for every part that is identified as a child of the product at step 77. The schematic data file is parsed at step 78 using methods known to a person skilled in the art and stores the data structure in memory. An inquiry at step 79 is made into whether the schematic data file contains any marker data. If there is no marker data present in the data file, the HTML necessary to create schematic pane 23 with HTML code is generated at step 80 to place the markers outside the schematic display area 24 and in proximity with its associated part in table 27 (see FIG. 4). At step 81, an inquiry is executed wherein the process checks to see if there are any more unprocessed Schematic Images and if so, parses the schematic data file at step 78. If there are no more schematic image files to process at step 81, the HTML generated in step 80 and any HTML generated to create schematic panes in steps 84 and 85 is concatenated and output to the browser at step 86 and the process terminates at step 90.

If the presence of marker data has been detected at step 79, the process continues to step 82 where the offset and max value information for the first marker listed in the data is read into memory. The marker's offset is compared to the schematic image's height and width and determines if the marker's offset is within the boundaries of the image's footprint at step 83. If the marker's offsets are outside the boundaries of the image's footprint, the process continues to step 85 which generates the HTML necessary to create schematic pane 23 with HTML code that places the markers outside the schematic display area 24 and in proximity with its associated part in table 27 with the associated drop list 33 set to the value present in the marker data.

If the marker's coordinates are calculated as being within the boundaries of the schematic image file at step 82, HTML display code is generated in step 84 that will display the marker offset by the amounts present in the data file, relative to the upper left corner of the schematic display area 24 with the associated drop list 33 set to the value present in the marker data. An inquiry is made at step 87 after the generation of HTML to create schematic panes in steps 84 and 85. The inquiry at step 87 determines whether there are more markers to be processed in the data file. If there are more markers to be processed, the application returns to step 82 and the application continues until there is no more marker data to process at step 87. Once there is no more marker data to process at step 87, an inquiry at step 88 is executed to check for any unprocessed schematic images. If there are unprocessed schematic images, the schematic data file is parsed at step 78. If there are no more schematic image files to process, any HTML generated to create schematic panes in steps 84 and 85 is concatenated and output to the browser at step 89 and the process terminates at step 90.

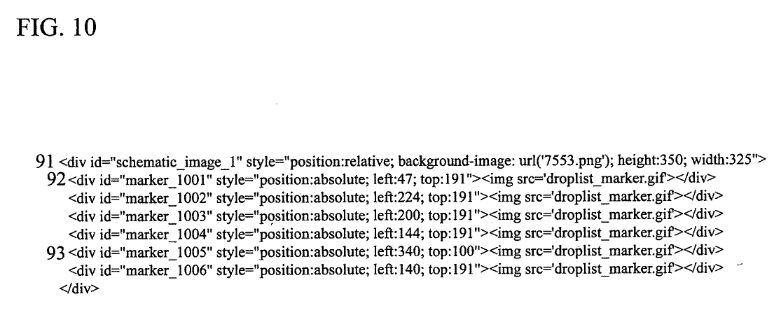

FIG. 10 illustrates a code fragment used to display markers and form elements relative to the schematic image according to the present invention. The HTML code fragment illustrated is a sample of the HTML generated in steps 80, 84 and 85 of FIG. 9. There is a container <div> object that has as its background images the schematic image file and its style attribute of position set to ‘relative’ 91. The height attribute of 91 is set to 350 pixels, and the width attribute is set to 325 pixels, the height and width of the schematic image file set as the background. Contained in 91 are <div> objects for each marker 92, where its ID attribute is a derivative of the keyword ‘marker_’ and the part's product ID as stored in the RDBMS. Each 92 has its style attribute of position set to ‘absolute’ which will make its display relative to the containing <div> 91 as determined by its left and top attribute settings. For example, 92 will be displayed 47 pixels right of the left border of the schematic image file, and 191 pixels down from the top of the schematic image file, whereas 93 is set to an offset of left:340 and top:100, which places it outside the boundaries of the schematic display pane 24. Finally, within each marker <div> is an HTML <img> tag that will display the form element on the customer user interface.

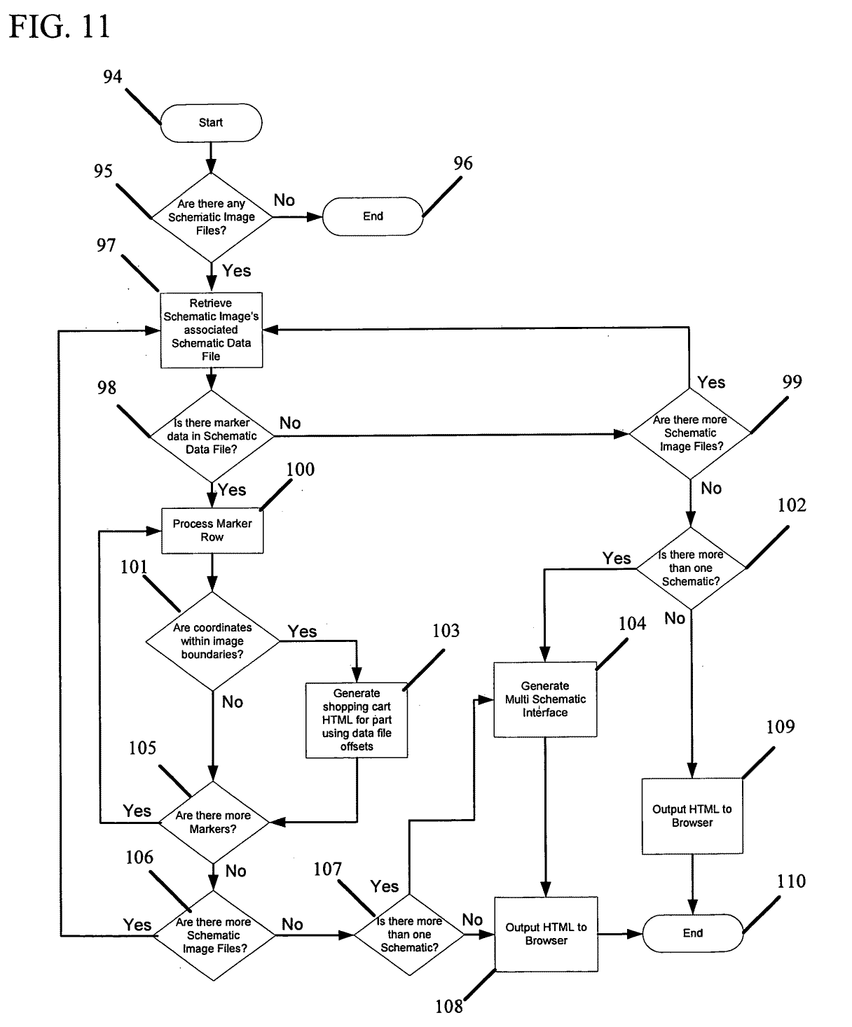

FIG. 11 is a flowchart of generating the customer interface using schematic data according to the present invention. The customer is presented with a display for a product at the purchase point using the Shopping System at step 94. The application then executes an inquiry at step 95 which reads the server's file system and looks for a directory with a name equivalent to the product ID and the presence of any schematic image files therein using methods known to those skilled in the art. If there is no directory and/or no schematic image files present, the process terminates at step 96. If the presence of schematic images returns true, step 97 parses the schematic data file using methods known to a person skilled in the art and stores the data structure in memory. An inquiry at step 98 is made into whether the schematic data file contains any marker data. If there is no marker data present in the data file at step 98, an inquiry is made at step 99 as to whether there are any more unprocessed schematic images and if so, parses the schematic data at step 97. If there are no more schematic image files to process at step 99, an inquiry is made as to whether more than one schematic has been processed that contains marker data at step 102. If there are zero or only one schematic with schematic data present, HTML is generated and output to the browser at step 109.

If there are two or more schematics, HTML is generated at step 104 to allow the customer to choose which schematic they would like to view, whether through a list of links or more appropriately through thumbnail images of the schematics. The process then continues to step 108 where any HTML generated in steps 103 and 104 is output to the browser, and the application terminates at step 110. If the presence of marker data is detected at step 98, the application continues to step 100 where the offset and max value information for the first marker listed in the data is read into memory. The marker's offset is compared to the schematic image's height and width and determines if the marker's offset is within the boundaries of the image's footprint at step 101. If the marker's offsets are outside the boundaries of the image's footprint, an inquiry is made into whether there are more markers to be processed in the data file at step 105. If there are more markers to process, the application returns to step 100 and this application continues until there is no more marker data to process. If the marker's coordinates are calculated as being within the boundaries of the schematic image file at step 101, HTML display code is generated at step 103 that will display HTML form code to the customer that allows them to select a quantity value for the part with the options limited by the marker's max attribute. The HTML generated is tailored to the methods of the existing Shopping System. The code is contained in a <div> object that has as its left and top attributes the marker's left offset and top offset attributes respectively. This will place the HTML at the same location that the user had placed the marker when using the Schematic Manager.

The process then continues to step 105 where an inquiry is made into whether there are more markers to be processed in the data file. If there are more markers to process, the application returns to step 100 and this application continues until there is no more marker data to process. If there are no more markers to be processed at step 105, an inquiry is made at step 106 to determine if there are more schematics to be processed and if so, begins with the next schematic image file and data at step 97. If there are no more schematics to be processed, an inquiry is made as to whether more than one schematic has been processed and contains marker data at step 107. If there are zero or one schematic with schematic data present, the HTML generated in block 103 is output at step 108 to the browser. If there are two or more schematics, HTML is generated at step 104 to allow the customer to choose which schematic they would like to review, whether through a list of links or more appropriately thumbnail images of the schematics. The application then continues to step 108 where any HTML generated in steps 103 and 104 is output to the browser at step 108, and the process terminates at step 110.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A method of dynamically generating a user interface to a user over a global network, comprising the steps of:
linking at least one form element to correspond to a feature on a web server resource such that said at least one form element can be superimposed in proximity to a visual display based on said web server resource;
providing a user access to an online shopping system, said online shopping system displaying a plurality of objects;
receiving a first user request for one of the plurality of objects;
obtaining said resource from said web server, said web server resource being associated with said one of the plurality of objects;
dynamically generating a visual display based on said web server resource, said generation of said visual display further including said at least one form element superimposed in proximity to the visual display; and
receiving at least one second user request pertaining to a form element.

2. The method of dynamically generating a user interface over a global network of claim 1, wherein said global network is the Internet.

3. The method of dynamically generating a user interface over a global network of claim 2, wherein said one of the plurality of objects corresponds to a product.

4. The method of dynamically generating a user interface over a global network of claim 1, wherein said first user request is performed using a cursor on a display, or an entry on a keyboard.

5. The method of dynamically generating a user interface over a global network of claim 1, wherein said visual display includes a schematic.

6. The method of dynamically generating a user interface over a global network of claim 1, wherein said visual display includes a diagram.

7. The method of dynamically generating a user interface over a global network of claim 1, wherein said visual display includes a photographic image.

8. The method of dynamically generating a user interface over a global network of claim 1, wherein said form elements are in hypertext transfer protocol.

9. The method of dynamically generating a user interface over a global network of claim 1, wherein said form elements include at least one data entry field.

10. The method of dynamically generating a user interface over a global network of claim 9, wherein said at least one data entry field includes a drop-down list.

11. The method of dynamically generating a user interface over a global network of claim 9, wherein said at least one data entry field comprises quantity, finish, size, color or engraving.

12. The method of dynamically generating a user interface over a global network of claim 1, wherein said superimposed in proximity means being close enough to the visual display to indicate a relationship to said user.

13. The method of dynamically generating a user interface over a global network of claim 3, further comprising, a schematic manager to dynamically generate said user interface.

14. The method of dynamically generating a user interface over a global network of claim 13, wherein said schematic manager utilizes a product review pane to provide descriptive data.

15. The method of dynamically generating a user interface over a global network of claim 13, wherein said schematic manager utilizes an upload pane for uploading files for dynamic generation of said user interface.

16. The method of dynamically generating a user interface over a global network of claim 13, wherein said schematic manager utilizes a schematic pane, said schematic pane including an image display and a table of parts.

17. The method of dynamically generating a user interface over a global network of claim 16, wherein said image display illustrates at least one uploaded schematic image file.

18. The method of dynamically generating a user interface over a global network of claim 17, wherein said table of parts contains data about at least one part.

19. The method of dynamically generating a user interface over a global network of claim 3, wherein said linking at least one form element to correspond to a feature on a web server resource means positioning a marker that corresponds to a form element to a feature on the resource.

20. The method of dynamically generating a user interface over a global network of claim 19, wherein said form element is populated based on the position of said marker and displayed on said user interface.

21. The method of dynamically generating a user interface over a global network of claim 20, further comprising at least one part, said at least one part making up a product, such that a parent-child relationship between said product and said at least one part, such that said dynamically generated user interface can provide said user with a visual display of said product and of said at least one part.

22. The method of dynamically generating a user interface over a global network of claim 1, further comprising the step of linking at least one descriptive data to correspond to a feature on a web server resource such that said at least one descriptive data can be superimposed in proximity to a visual display based on said web server resource.

23. The method of dynamically generating a user interface over a global network of claim 1, further comprising the step of dynamically generating a second visual display based on said at least one second user request.

24. The method of dynamically generating a user interface over a global network of claim 1, further comprising the step of allowing said user to purchase a product pertaining to said second visual display.
